(19) United States
(12) Patent Application Publication
(10) Pub. No.: US 2018/0308066 A1
(43) Pub. Date: Oct. 25, 2018

(54) INTERACTIVE MEAL PREPARATION USING RECIPES

(71) Applicant: FUJITSU LIMITED, Kawasaki-shi (JP)

(72) Inventor: Naomi HADATSUKI, San Jose, CA (US)

(73) Assignee: FUJITSU LIMITED, Kawasaki-shi (JP)

(21) Appl. No.: 15/495,884

(22) Filed: Apr. 24, 2017

(51) Int. Cl. G06Q 10/10

(52) U.S. Cl. CPC G06Q 10/1095

(57) ABSTRACT

A method to generate a cooking schedule may include identifying the recipes and corresponding cooking steps and time durations for the cooking steps for the recipes. The method may also include determining cooking blocks and corresponding cooking times for the recipes based on the cooking steps. The method may further include generating a cooking schedule for the recipes, where the cooking schedule satisfies required completion times for completing each of the recipes.

### FIELD

The described technology relates generally to cooking aids.

### BACKGROUND

Cooking can be a joy and a challenge at the same time. For many people, cooking and sharing a delicious and nutritious meal at home brings a lot of joy and satisfaction. This is also evidenced by the celebrity status conferred on popular chefs as well as the popularity of numerous cooking shows.

The challenge for many is in deciding what to cook, knowing how to cook it, and, probably most importantly, actually cooking the food. Many people rely on recipes to prepare dishes, such as appetizers, main dishes, side dishes, salads, deserts, etc. In addition to cookbooks, cooking shows and, increasingly, the Internet have become a great source of recipes as well as step-by-step instructions on how to prepare the dishes using the recipes.

Even with recipes and step-by-step instructions, many still find it difficult to follow the instructions and properly prepare the dishes. This is because the recipes fail to account for factors such as the skill of the person preparing the food, the number of dishes that are being prepared at the same time, the time available for preparing the food, etc. These recipes generally assume a cook of a certain level of expertise, certain types of appliances and cooking tools, and that the recipe is the only dish that is being prepared at that time.

Unfortunately, many are not of the same skill level as that assumed by the writer of the recipe. Rather, many people may be considered culinarily challenged, especially when preparing dishes for the first time. Additionally, people are likely to be cooking a number dishes at the same time, and are likely to find it difficult to properly follow the recipes. Moreover, people have difficulty preparing multiple dishes and having all or most of the dishes completed in time. This is especially so when some of the dishes are not being prepared from these recipes, but, rather, from the cook's own recollection and creativity.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to some examples, methods to generate cooking schedules for meals are described. An example method may include identifying a first recipe, the first recipe including a first set of cooking steps, and each of the cooking steps in the first set of cooking steps including a time duration. The method may also include identifying a second recipe, the second recipe including a second set of cooking steps, and each of the cooking steps in the second set of cooking steps including a time duration. The method may further include determining a first set of cooking blocks for the first recipe based on the first set of cooking steps, where each of the cooking blocks in the first set of cooking blocks includes a time duration, and determining a second set of cooking blocks for the second recipe based on the second set of cooking steps, where each of the cooking blocks in the second set of cooking blocks includes a time duration. The method may include determining a first required completion time for the first recipe, and determining a second required completion time for the second recipe. The method may additionally include generating a cooking schedule for the first recipe and the second recipe, where the cooking schedule satisfies the first required completion time and the second required completion time, and presenting the cooking schedule.

The objects and advantages of the embodiments will be realized and achieved at least by the elements, features, and combinations particularly pointed out in the claims. Both the foregoing general description and the following detailed description are given as examples, are explanatory and are not restrictive of the invention, as claimed.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates selected components of an example interactive meal preparation system;

FIG. 2 illustrates selected components of an example general purpose computing system, which may be used to provide interactive meal preparation;

FIG. 3 illustrates an overview of an environment in which the interactive meal preparation system may operate;

FIG. 4 is a flow diagram that illustrates an example process to generate step-by-step cooking instructions for a recipe that may be performed by a computing system such as the computing system of FIG. 2;

FIGS. 5A and 5B are a flow diagram that illustrates an example process to generate minute-by-minute cooking schedule for a meal that may be performed by a computing system such as the computing system of FIG. 2; and

FIG. 6 is a flow diagram that illustrates an example process to tune a minute-by-minute cooking schedule in real-time that may be performed by a computing device such as the computing device in FIG. 2,

all arranged in accordance with at least some embodiments described herein.

### DESCRIPTION OF EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to preparation of multiple culinary dishes using recipes and step-by-step instructions.

Technology is disclosed for interactively generating cooking schedules for meals including multiple culinary dishes based on recipes (the “technology”). A meal typically includes multiple dishes. Preparation of a meal requires proper planning so that the dishes in the meal can be properly prepared by a cook in time for the meal. The time needed to properly prepare the dishes and the cook's schedule (e.g., availability to prepare the dishes) are just two factors that need to be considered in the planning. Proper planning may also require the cook to multitask; that is, be able to properly prepare multiple dishes at the same time in order to complete the cooking in a timely manner. The difficulty may be compounded if some of the dishes are being prepared without reliance on recipes. Various embodiments of the technology facilitate the proper and timely preparation of the multiple dishes included in a meal.

In some embodiments of the technology, a user, such as a cook, uses the technology to plan and properly prepare a meal. For example, the technology may provide a user interface through which the user can specify the specifics of a meal, including the dishes to be included in the meal and the time (e.g., date and time) the meal is to take place. In some embodiments, the technology may allow the user to upload recipes for one or more of the dishes. The technology identifies a recipe for each dish included in the meal. For example, if a recipe is not provided by the user, the technology may identify a recipe from another source such as a data store, the Internet, etc.

The technology processes each recipe to determine the recipe's ingredients, cooking steps (set of cooking steps for the recipe), and a time duration for each cooking step (i.e., a duration or time needed to complete the cooking step). The cooking steps and corresponding time durations may be specified by the recipe. If so, the technology is able to determine the cooking steps and corresponding time durations by parsing the recipe. If some or all of the cooking steps and corresponding time durations are not specified by the recipe, the technology can analyze the recipe to determine the cooking steps and corresponding time durations. For example, the technology may determine a cooking step based on action or cooking verbs (e.g., fry, bake, stir, boil, pour, mix, chop, drain, season, peel, etc.) included in the recipe. The technology may determine (e.g., estimate) a corresponding time duration for a cooking step based on attributes, such as, by way of example, the action verbs, types of cooking tools, types of appliances, ingredients, number of ingredients, etc., included in the recipe.

In some embodiments, the technology may assign weights to the attributes, and determine (e.g., estimate) respective corresponding time durations for the cooking steps based on the attributes and their corresponding weights. For example, certain types of ingredients (e.g., certain ingredients may be known to take a longer time to prepare) may be assigned a greater weight than other types of ingredients. Similarly, certain types action verbs (e.g., certain cooking actions may be known to be more difficult to perform) may be assigned greater weights that other types of action verbs.

The technology identifies candidate or possible interruption points in the cooking process by determining the cooking steps in a recipe that can be interrupted or, conversely, that need to be performed continuously (i.e., without interruption). The technology can determine the interruption points based on attributes, such as, by way of example, time expressions and time allocations (e.g., for 10 minutes, longer than 30 minutes, etc.), action verbs (e.g., bake, simmer, chill, freeze, slow cook, rest, etc.), tools (e.g., blender, mixer, knife, etc.), appliances (e.g., oven, slow cooker, refrigerator, freezer, etc.), etc., included in the cooking steps. The technology may then determine cooking blocks (i.e., set of cooking blocks) for each recipe based on the identified interruption points. Accordingly, the cooking steps included in a cooking block are cooking steps that are to be performed consecutively, for example, to maintain the quality of the dish. In some embodiments, the technology may also consider the weights of the attributes in determining the interruption points. By way of example, the six cooking steps “preheat oven to 350 degrees,” “line turkey roaster with sheets of aluminum,” “stir together the parsley, rosemary, sage, thyme, lemon pepper, and salt in a bowl,” “rub the herb mixture into cavity of the turkey,” “place aluminum foil over the turkey,” and “seal the turkey” in a recipe may be determined to be a single cooking block. That is, the interruption points are prior to the start of the first of the six cooking steps, and at the end of the sixth of the six cooking steps, but not during the cooking block.

The technology may identify certain cooking steps as interruptible cooking steps. Cooking steps that do not require the continuous attention or actions from the cook to complete may be classified as interruptible cooking steps. That is, the cook can be interrupted while performing these cooking steps to perform other tasks or actions. For example, in the cooking block example above, the cooking step “preheat oven to 350 degrees” may be identified as an interruptible cooking step, where the cook is able to perform other actions during this cooking action. Referring again to the cooking block example above, the cook is able to perform one or more of the following cooking actions without having to idly wait for the oven to finish preheating to 350 degrees. In another example, the technology may identify a cooking step “bake turkey in oven for 3 hours” as an interruptible cooking step. As with other interruptible cooking blocks, the cook is allowed to perform other actions (tasks) during the performance of the interruptible cooking step (e.g., while the turkey is baking in the oven for 3 hours).

The technology may determine any required completion times for each recipe (i.e., dish). The user may specify the required completions times, for example, when specifying the specifics of the meal. Additionally or alternatively, the technology may determine the required completion times independent of the user specifying the required completion times. For example, the technology can determine the required completion times from factors such as the specified meal time, time required to cook the identified dishes, other actions or tasks the cook will be undertaking during the time period preceding the specified meal time, dish preparation preferences not indicated in the recipe (e.g., the technology may determine from an external source of cooking information that a pie should be allowed to cool for one hour before serving, that a roast should be allowed to cool for 30 minutes before serving, etc.), and the like. The technology can then sequence the cooking blocks for each recipe based on the required completion time of the recipe. The sequence of cooking blocks is a logical ordering of the cooking blocks to prepare the dish by following the recipe.

In some embodiments, the technology may provide an interface with which the user can provide access to the user's calendar application. The technology can then access the user's calendar to determine the times that the user is available to undertake preparation of the meal or parts of the meal. Additionally or alternatively, the technology may provide a user interface through which the user can specify the times (time periods) that the user is unavailable to prepare the meal.

The technology can then generate a cooking schedule for the preparation of the meal based on some or all of the information discussed above. In some embodiments, the technology may generate the minute-by-minute cooking schedule based on a prioritization of the dishes included in the meal. For example, the dishes may be prioritized according to factors, such as, by way of example, cooking time for the recipe, number of cooking blocks in the recipe, duration of the cooking blocks in the recipe, and the like. For example, the technology may determine that the recipe for dish #1 includes four cooking blocks, and that the last cooking block is an interruptible cooking step having a time duration of three hours; the recipe for dish #2 includes six cooking blocks that can all be completed in 45 minutes; and the recipe for dish #3 includes three cooking blocks that can all be completed in one hour. In this example, the technology may prioritize the dishes from highest to lowest as follows: dish #2, dish #3, and dish #1. That is, there is no need to assign the highest priority to dish #1 because the characteristics of the last block in the recipe. That is, dish #2 and dish #3 can be prepared while the last block in the recipe for dish #1 is being performed.

The technology may consider other factors, such as, by way of example, the user's schedule (e.g., time periods that the user is available to prepare the meal), the time durations of the cooking blocks, required recipe completion times, etc., in generating the minute-by-minute cooking schedule. For example, if the user's schedule indicates that the user will be available for a 30 minute time period, a one hour time period, and a 90 minute time period, the technology does not allocate a cooking block or blocks that take a total of 45 minutes to complete in the 30 minute time period. As a result, the minute-by-minute cooking schedule may include one or more cooking blocks (subset of cooking blocks) of a first recipe being followed by one or more cooking blocks (subset of cooking blocks) of a second, different recipe before the first recipe is completed. Stated another way, the minute-by-minute cooking schedule for recipe A and recipe B may have segments where the user is in the process of preparing recipe A and recipe B before either recipe A or recipe B completed.

In some embodiments, the technology may combine cooking steps from different recipes. For example, if both recipe #1 and recipe #2 each includes a cooking step “mince one onion,” the technology may combine these two cooking steps into a cooking step “mince two onions and separate into two equal amounts.” As another example, suppose the two cooking steps are “bake pie in oven at 325 degrees for one hour” and “bake casserole in oven at 325 degrees for 50 minutes.” The technology may determine that the indicated baking times are independent of the number of items in the oven at the same time, and combine the two cooking steps to be performed concurrently.

In some embodiments, the technology may request confirmation of the user's availability for the cooking blocks included in the minute-by-minute cooking schedule. For example, the technology may present the cooking blocks to the user, and request the user to confirm the user's availability to perform the cooking blocks uninterrupted (i.e., the user's acceptance of the cooking blocks). If the user fails to confirm, the technology may redetermine the cooking blocks.

In some embodiments, the technology may request confirmation of the user's availability to prepare the meal according to the minute-by-minute cooking schedule. For example, the technology may present the cooking blocks and corresponding times to the user, and request the user to confirm the user's availability to perform the cooking blocks at the indicated times. If the user fails to confirm, the technology may redetermine the cooking blocks and generate another minute-by-minute cooking schedule.

In some embodiments, the technology may provide one or more interfaces with which to connect and communicate with cooking tools, appliances, smart appliances, etc. Using these interfaces, the technology is able to obtain real-time feedback from the cooking tools, appliances, smart appliances, etc. during the preparation of the meal and revise the minute-by-minute cooking schedule based on the received feedback. For example, a smart oven may provide feedback indicating that the roast cooking in the smart oven needs to cook for an additional 15 minutes. The technology can then regenerate the minute-by-minute cooking schedule based on this real-time feedback from the smart oven.

In some embodiments, the technology may provide an interface with which the user can provide real-time feedback during the preparation of the meal (i.e., while performing the minute-by-minute cooking schedule). For example, the minute-by-minute cooking schedule may include a cooking step and a corresponding time duration for performing the cooking step. In performing the cooking step, the user may provide feedback indicating that the user needs an additional three minutes to complete the cooking step. The technology can then regenerate the minute-by-minute cooking schedule based on this real-time feedback from the user.

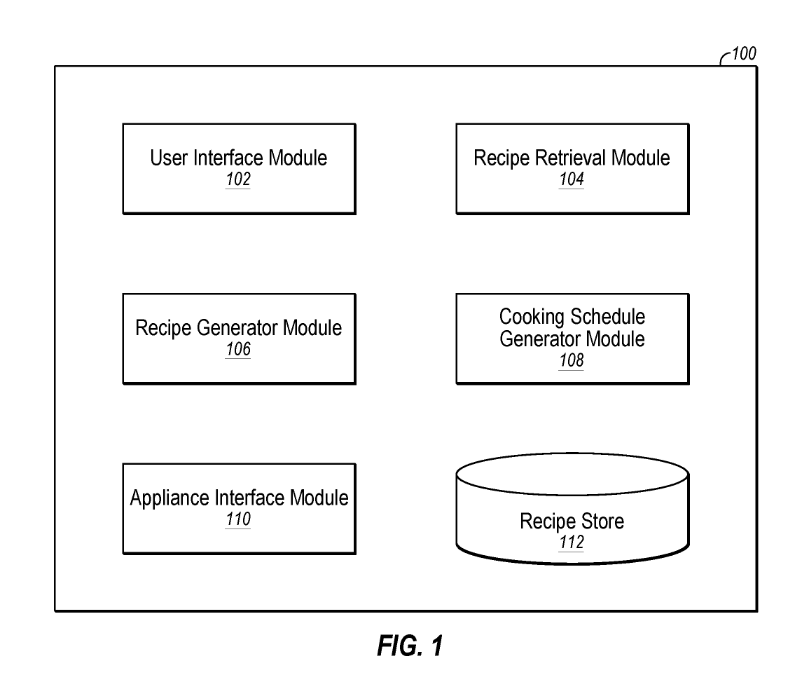

Turning now to the figures, FIG. 1 illustrates selected components of an example interactive meal preparation system 100, arranged in accordance with at least some embodiments described herein. As depicted, interactive meal preparation system 100 includes a user interface module 102, a recipe retrieval module 104, a recipe generator module 106, a cooking schedule generator module 108, an appliance interface module 110, and a recipe store 112. In various embodiments, additional components (not illustrated) or a subset of the illustrated components can be employed without deviating from the scope of the claimed technology.

User interface module 102 may provide an interface with which a user, such as a cook, may use and/or interact with interactive meal preparation system 100. Suitable types of user interfaces include, by way of example, a graphical user interface (GUI), a touch interface, an audio interface, gesture interface, an image interface, and the like. For example, a cook may use user interface module 102 to upload personal recipes onto interactive meal preparation system 100, upload images of dishes, cooking tools (utensils), appliances, etc., request a minute-by-minute cooking schedule for a meal, provide information regarding a meal (e.g., the dishes included in the meal, requested completion times, planned meal time, etc.), provide information regarding cooking tools and/or appliances available to prepare the meal, provide information regarding the cook's schedule and/or availability, provide feedback to interactive meal preparation system 100 during the preparation of the meal, etc. In some embodiments, interactive meal preparation system 100 may identify an object (e.g., dish, appliance, cooking tool, etc.) from an uploaded image.

Recipe retrieval module 104 may retrieve one or more recipes for processing by interactive meal preparation system 100. For example, recipe retrieval module 104 may retrieve the recipes from recipe store 112. Additionally or alternatively, recipe retrieval module 104 may retrieve recipes from an external source, such as the Internet, cooking web sites, etc.

Recipe generator module 106 may analyze a recipe for a dish to determine the cooking steps and corresponding time durations to prepare the dish. For example, a recipe provided by a cook may be incomplete in that not all cooking steps to prepare the dish are described in the recipe. Likewise, an existing recipe (e.g., a recipe retrieved from the Internet) may be incomplete in that not all cooking steps to prepare the dish are described in the recipe. In some embodiments, recipe generator module 106 may determine the cooking steps based on action or cooking verbs (e.g., decorate, dry, glaze, lay, lift, melt, defrost, pack, pour, reduce, beat, simmer, strain, stir, etc.) included in the recipe (e.g., the action or cooking verbs used to describe how to make or prepare the dish). Recipe generator module 106 may determine (e.g., estimate) respective corresponding time durations for performing the cooking steps based on attributes, such as, by way of example, the action verb, cooking tools, types of appliances, types of ingredients, number of ingredients, etc., included in the recipe (e.g., the attributes used to describe how to make or prepare the dish).

In some embodiments, recipe generator module 106 may also assign weights to the attributes, and determine (e.g., estimate) respective corresponding time durations for the cooking steps based on the attributes and their corresponding weights. For example, certain types of ingredients (e.g., certain ingredients may be known to take a longer time to prepare) may be assigned a greater weight than other types of ingredients. Similarly, certain types of action verbs, cooking tools, appliances, etc., may be assigned greater weights than other types of action verbs, cooking tools, appliances, etc. Interactive meal preparation system 100 may assign or set the weights for the attributes. Additionally or alternatively, the cook may specify the weights for one or more of the attributes, for example, using user interface module 102. In some embodiments, interactive meal preparation system 100 may continually revise one or more of the weights based on, for example, historical data, increased experience (e.g., repeated use of the recipe by the same cook), and the like.

Cooking schedule generator module 108 may generate a minute-by-minute cooking schedule for a meal (i.e., minute-by-minute cooking schedule for preparing the dishes included in a meal) in accordance with the various embodiments described herein. Cooking schedule generator module 108 may utilize one or more of the modules and/or components of interactive meal preparation system 100 in generating the minute-by-minute cooking schedule. In some embodiments, cooking schedule generator module 108 may revise or regenerate the minute-by-minute cooking schedule, for example, based on feedback from the cook, one or more appliances, etc.

Appliance interface module 110 may communicate with one or more appliances, such as smart appliances. Appliance interface module 110 may receive (obtain) information or feedback from connected smart appliances (e.g., an alert that something is wrong, an alert that the cookies are done, an alert that additional time is needed, etc.) and/or send instructions to control the operation of connected smart appliances (e.g., instruction to preheat an oven, instruction to turn on, instruction to turn off, instruction to reduce temperature, instruction to increase cooking time, instruction to decrease cooking time, etc.).

Recipe store 112 may store data, such as, by way of example, recipes, user data, meal data, smart appliance data, or other data that may be used by interactive meal preparation system 100. Recipe store 112 may be implemented using any computer-readable storage media suitable for carrying or having data or data structures stored thereon. In some embodiments, interactive meal preparation system 100 may be integrated or included in a smart appliance, such as, by way of example, a smart refrigerator, a smart oven, etc.

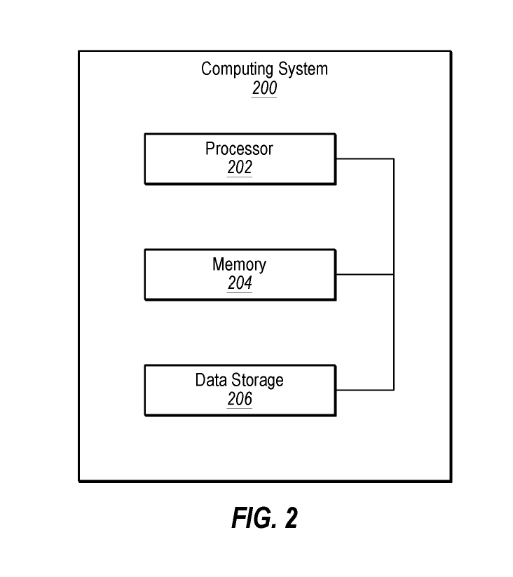

FIG. 2 illustrates selected components of an example general purpose computing system 200, which may be used to provide interactive meal preparation, arranged in accordance with at least some embodiments described herein. Computing system 200 may be configured to implement or direct one or more operations associated with some or all of the components and/or modules associated with interactive meal preparation system 100 of FIG. 1. Computing system 200 may include a processor 202, a memory 204, and a data storage 206. Processor 202, memory 204, and data storage 206 may be communicatively coupled.

In general, processor 202 may include any suitable special-purpose or general-purpose computer, computing entity, or computing or processing device including various computer hardware, firmware, or software modules, and may be configured to execute instructions, such as program instructions, stored on any applicable computer-readable storage media. For example, processor 202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, processor 202 may include any number of processors and/or processor cores configured to, individually or collectively, perform or direct performance of any number of operations described in the present disclosure. Additionally, one or more of the processors may be present on one or more different electronic devices, such as different servers.

In some embodiments, processor 202 may be configured to interpret and/or execute program instructions and/or process data stored in memory 204, data storage 206, or memory 204 and data storage 206. In some embodiments, processor 202 may fetch program instructions from data storage 206 and load the program instructions in memory 204. After the program instructions are loaded into memory 204, processor 202 may execute the program instructions.

For example, in some embodiments, any one or more of the components and/or modules of interactive meal preparation system 100 may be included in data storage 206 as program instructions. Processor 202 may fetch some or all of the program instructions from the data storage 206 and may load the fetched program instructions in memory 204. Subsequent to loading the program instructions into memory 204, processor 202 may execute the program instructions such that the computing system may implement the operations as directed by the instructions.

Memory 204 and data storage 206 may include computer-readable storage media for carrying or having computer-executable instructions or data structures stored thereon. Such computer-readable storage media may include any available media that may be accessed by a general-purpose or special-purpose computer, such as processor 202. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause processor 202 to perform a certain operation or group of operations.

Modifications, additions, or omissions may be made to computing system 200 without departing from the scope of the present disclosure. For example, in some embodiments, computing system 200 may include any number of other components that may not be explicitly illustrated or described herein.

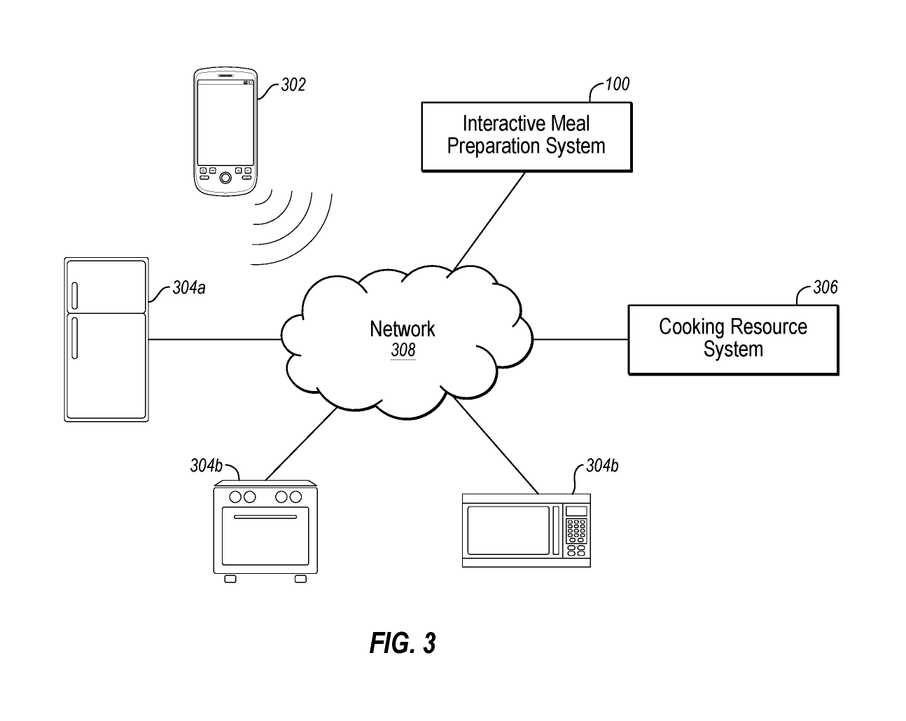

FIG. 3 illustrates an overview of an environment 300 in which interactive meal preparation system 100 may operate, arranged in accordance with at least some embodiments described herein. Environment 300 may include interactive meal preparation system 100 illustrated as operating in a networked environment using logical connections to one or more remote computing systems, e.g., a mobile device 301, smart appliances 304a, 304b, and 304c, and a cooking resource system 306, through a network 308. Mobile device 301 may be the cook's smart phone, and may be used to communicate with interactive meal preparation system 100. For example, interactive meal preparation system 100 may generate alerts (e.g., an alert to attend to a specific cooking step, an alert that an appliance requires attending to, etc.) to the cook on mobile device 301. As another example, interactive meal preparation system 100 may access the cook's calendar (schedule) using mobile device 301. As a further example, interactive meal preparation system 100 may provide a mobile user interface, which may be executed on mobile device 301, to allow the cook to interact with interactive meal preparation system 100 as described herein.

Smart appliances 304a-304c may be individually referred to herein as smart appliance 304 or collectively referred to herein as smart appliances 304. Smart appliances 304 may communicate with interactive meal preparation system 100 to facilitate the generation, revision, and/or use of minute-by-minute cooking schedules as described herein. As depicted, smart appliance 304a may be a smart refrigerator, smart appliance 304b may be a smart oven, and smart appliance 304c may be a smart microwave oven. The number of smart appliances depicted in environment 300 is for illustration, and one skilled in the art will appreciate that there may be a different number of smart appliances. Cooking resource system 306 may provide recipes, cooking information, appliance information, etc., for example, to interactive meal preparation system 100. Network 308 can be a local area network, a wide area network, the Internet, and/or other wired or wireless networks.

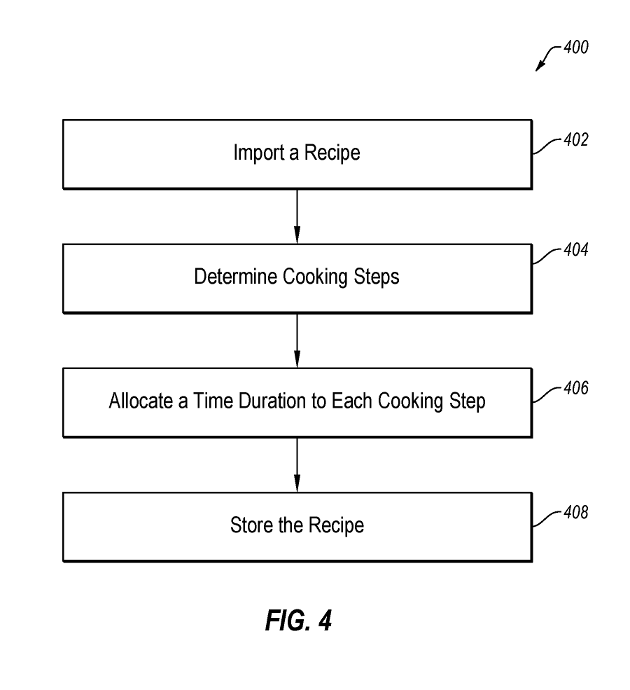

FIG. 4 is a flow diagram 400 that illustrates an example process to generate step-by-step cooking instructions for a recipe that may be performed by a computing system such as the computing system of FIG. 2, arranged in accordance with at least some embodiments described herein. Example processes and methods may include one or more operations, functions or actions as illustrated by one or more of blocks 402, 404, 406, and/or 408, and may in some embodiments be performed by a computing system such as computing system 200 of FIG. 2. The operations described in blocks 402-408 may also be stored as computer-executable instructions in a computer-readable medium such as memory 204 and/or data storage 206 of computing system 200.

As depicted by flow diagram 400, the example process to generate step-by-step cooking instructions for a recipe may begin with block 402 (“Import a Recipe”), where a user, such as a cook, may use user interface module 102 to upload a recipe onto interactive meal preparation system 100. For example, the user may upload a personal recipe for later use.

Block 402 may be followed by block 404 (“Determine Cooking Steps”), where recipe generator module 106 may determine the set of cooking steps for the uploaded recipe. In instances where a cooking step is not clearly described in the recipe, recipe generator module 106 may determine the cooking step based on the contents of the recipe.

Block 404 may be followed by block 406 (“Allocate a Time Duration to Each Cooking Step”), where recipe generator module 106 may determine a time duration necessary to perform each cooking step in the set of cooking steps, and associate (allocate) the time duration to the respective cooking step. In instances where a time duration for a cooking step is not specified in the recipe, recipe generator module 106 may estimate the time duration based on the contents of the recipe.

Block 406 may be followed by block 408 (“Store the Recipe”), where recipe generator module 106 may create the step-by-step cooking instructions for the recipe based on the set of cooking steps (block 404) and the respective time durations (block 406), and store the recipe, including the step-by-step cooking instructions, in recipe store 112.

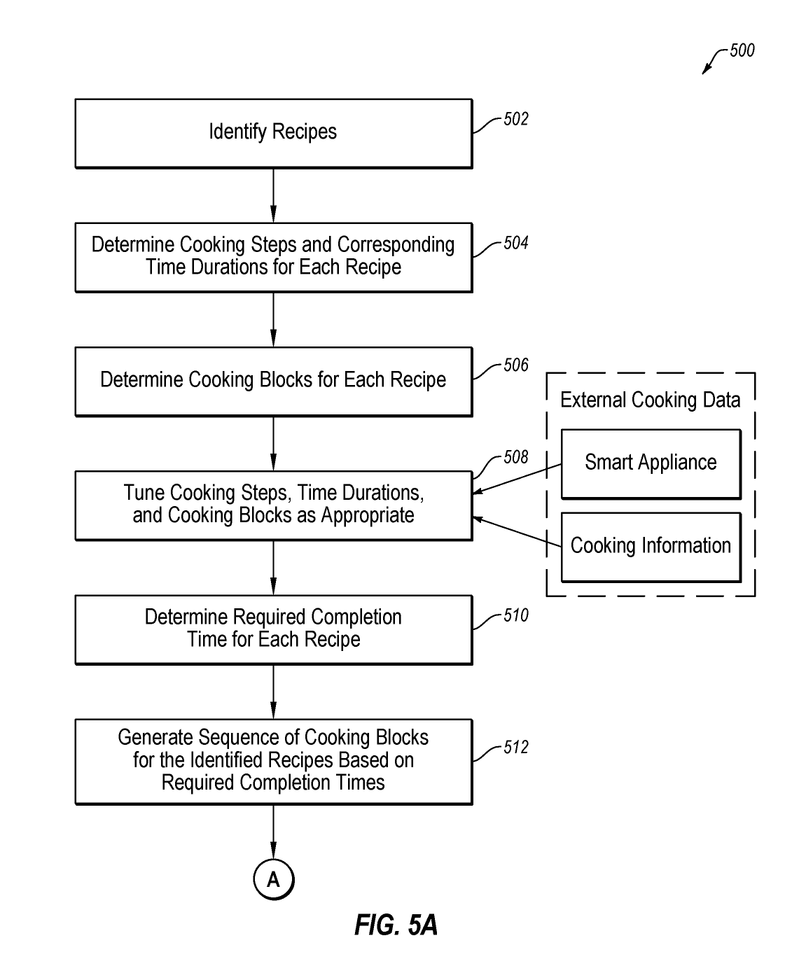

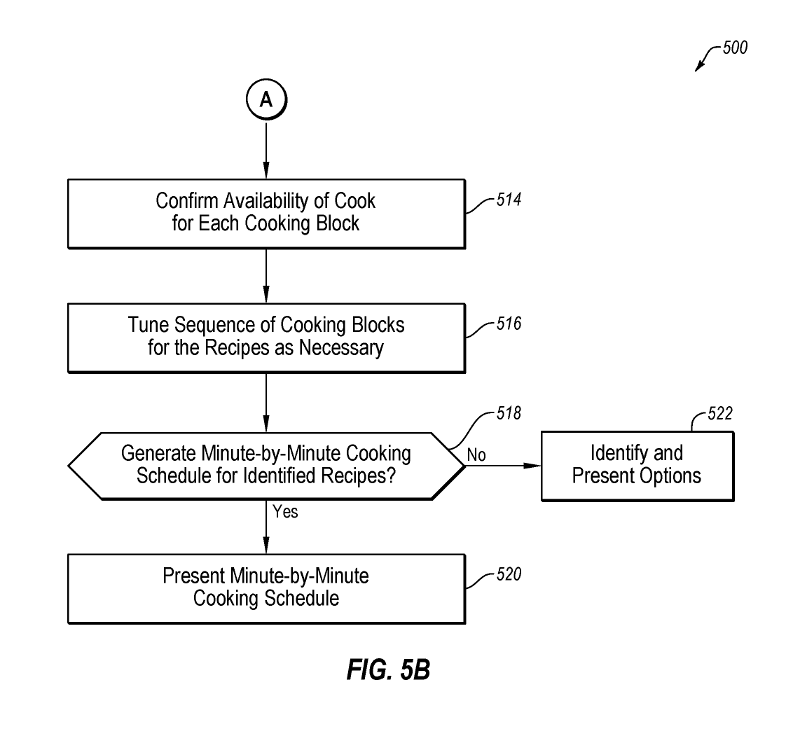

FIGS. 5A and 5B are a flow diagram 500 that illustrates an example process to generate minute-by-minute cooking schedule for a meal that may be performed by a computing system such as the computing system of FIG. 2, arranged in accordance with at least some embodiments described herein. Example processes and methods may include one or more operations, functions or actions as illustrated by one or more of blocks 502, 504, 506, 508, 510, 512, 514, 516, 518, 520, and/or 522, and may in some embodiments be performed by a computing system such as computing system 200 of FIG. 2. The operations described in blocks 502-522 may also be stored as computer-executable instructions in a computer-readable medium such as memory 204 and/or data storage 206 of computing system 200.

As depicted by flow diagram 500, the example process to generate a minute-by-minute cooking schedule for a meal may begin with block 502 (“Identify Recipes”), where interactive meal preparation system 100 may use recipe retrieval module 104 to identify the recipes for the dishes included in a meal. For example, a cook who may be about to start preparing a meal may use user interface module 102 to request a minute-by-minute cooking schedule for a meal the cook is planning. The cook may have previously provided the specifics (e.g., the dishes included in the meal, requested completion times of the dishes, scheduled meal time, etc.) of the meal. Additionally or alternatively, the cook may provide some of the meal specifics, including recipes for one or more dishes, at the time of making the request.

Block 502 may be followed by block 504 (“Determine Cooking Steps and Corresponding Time Durations for Each Recipe”), where recipe generator module 106 may determine the set of cooking steps, and corresponding time durations for performing the respective cooking steps, for each recipe included in the meal (i.e., each recipe to include in the minute-by-minute cooking schedule).

Block 504 may be followed by block 506 (“Determine Cooking Blocks for Each Recipe”), where cooking schedule generator module 108 may determine the set of cooking blocks for each recipe included in the meal. For example, cooking schedule generator module 108 may determine candidate interruption points in the cooking process based on the characteristics of the cooking steps in a recipe, and may determine the set of cooking blocks based on the candidate interruption points.

Block 506 may be followed by block 508 (“Tune Cooking Steps, Time Durations, and Cooking Blocks as Appropriate”), where cooking schedule generator module 108 may tune one or more of the cooking steps, time durations, and cooking blocks, for example, based on external cooking data. For example, as depicted in flow diagram 500, information regarding one or more smart appliances specified in the recipes may indicate preferred settings, operating modes, etc. In this instance, cooking schedule generator module 108 may appropriately tune the cooking steps, time durations, or cooking blocks based on this information. In another example, also as depicted in flow diagram 500, cooking information regarding preparation of one or more dishes included in the meal may indicate preferred preparation techniques, conditions, settings, etc. In this instance, cooking schedule generator module 108 may appropriately tune the cooking steps, time durations, or cooking blocks based on this information. In some embodiments, interactive meal preparation system 100 may obtain some or all of the external cooking data, for example, from cooking resource system 306.

Block 508 may be followed by block 510 (“Determine Required Completion Time for Each Recipe”), where cooking schedule generator module 108 may determine a required cooking completion time for each recipe included in the meal.

Block 510 may be followed by block 512 (“Generate Sequence of Cooking Blocks for the Identified Recipes based on Required Completion Times”), where cooking schedule generator module 108 may generate a sequence of cooking blocks for each recipe included in the meal based on the respective requested completion time for each recipe.

Block 512 may be followed by block 514 (“Confirm Availability of Cook for Each Cooking Block”), where cooking schedule generator module 108 may confirm the availability of the cook to perform each of the cooking blocks in the sequence of cooking blocks. For example, cooking schedule generator module 108 may use user interface module 102 to allow the cook to review the cooking blocks and to provide confirmation of the cook's availability.

Block 514 may be followed by block 516 (“Tune Sequence of Cooking Blocks for the Recipes as Necessary”), where cooking schedule generator module 108 may tune or regenerate the sequence of cooking blocks for each recipe included in the meal in response to the cook's failure to confirm availability to perform one or more of the cooking blocks. For example, if the cook indicates that the cook is unavailable to perform any of the cooking blocks (block 514), cooking schedule generator module 108 can tune the sequence of cooking blocks or generate a new sequence of cooking blocks for each recipe, and confirm the availability of the cook to perform each of the cooking blocks in the new sequence.

Block 516 may be followed by decision block 518 (“Generate Minute-by-Minute Cooking Schedule for Identified Recipes?”), where cooking schedule generator module 108 may determine whether a minute-by-minute cooking schedule for the recipes included in the meal (i.e., a minute-by-minute cooking schedule for preparing the dishes corresponding to the recipes included in the meal) can be generated. Cooking schedule generator module 108 may not be able to generate a minute-by-minute cooking schedule for the recipes included in the meal that satisfies all of the conditions, such as, by way of example, the cooks availability and/or schedule, requested recipe completion times, indicated meal time, etc. If cooking schedule generator module 108 is able to generate a minute-by-minute cooking schedule for the recipes included in the meal that satisfies all of the conditions, then cooking schedule generator module 108 generates the minute-by-minute cooking schedule, and presents the minute-by-minute cooking schedule (block 520, “Present Minute-by-Minute Cooking Schedule”), for example, using user interface module 102 for viewing by the cook.

In some embodiments, cooking schedule generator module 108 may request confirmation of the cook's satisfaction (i.e., acceptance) of the minute-by-minute cooking schedule. For example, cooking schedule generator module 108 may use user interface module 102 to allow the cook to review the minute-by-minute cooking schedule and to provide confirmation of the cook's satisfaction. If the cook is not satisfied with one or more aspects of the minute-by-minute cooking schedule, cooking schedule generator module 108 may attempt to generate another minute-by-minute cooking schedule that addresses some or all of the aspects the cook was not satisfied with.

Otherwise, if cooking schedule generator module 108 is unable to generate a minute-by-minute cooking schedule for the recipes included in the meal that satisfies all of the conditions, then cooking schedule generator module 108 may identify possible options for preparing the meal, and present the identified options (block 522, “Identify and Present Options”), for example, using user interface module 102 to the cook. For example, an option may be to delay the meal by one hour, and cooking schedule generator module 108 can ask the cook whether the meal can be delayed one hour. If the cook indicates that the meal can be delayed one hour, cooking schedule generator module 108 may generate a minute-by-minute cooking schedule for the meal based on the new meal time.

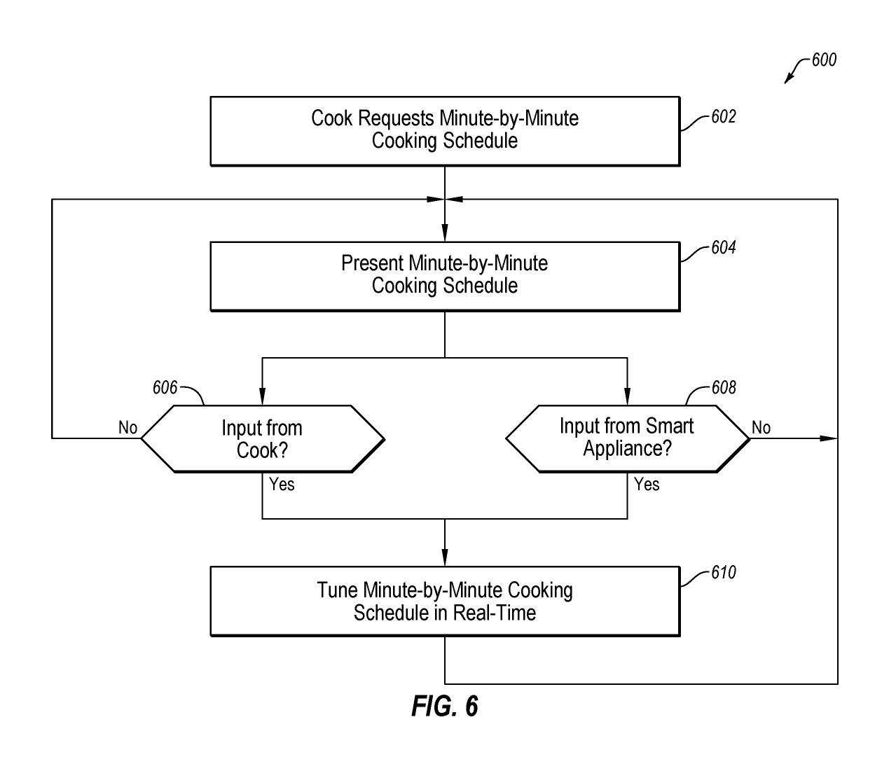

FIG. 6 is a flow diagram 600 that illustrates an example process to tune a minute-by-minute cooking schedule in real-time that may be performed by a computing device such as the computing device in FIG. 2, arranged in accordance with at least some embodiments described herein. Example processes and methods may include one or more operations, functions or actions as illustrated by one or more of blocks 602, 604, 606, 608, and/or 610, and may in some embodiments be performed by a computing system such as computing system 200 of FIG. 2. The operations described in blocks 602-610 may also be stored as computer-executable instructions in a computer-readable medium such as memory 204 and/or data storage 206 of computing system 200.

As depicted by flow diagram 600, the example process to tune a minute-by-minute cooking schedule in real-time may begin with block 602 (“Cook Requests Minute-by-Minute Cooking Schedule”), where a cook may request interactive meal preparation system 100 to present (display) a minute-by-minute cooking schedule for a meal the cook will be preparing.

Block 602 may be followed by block 604 (“Present Minute-by-Minute Cooking Schedule”), where interactive meal preparation system 100 may use user interface module 102 to present (display) the requested minute-by-minute cooking schedule for the meal for viewing by the cook.

Block 604 may be followed by decision block 606 (“Input from Cook?”), where interactive meal preparation system 100 determines whether there is any input from the cook. For example, the cook may use user interface module 102 to provide comments (e.g., requested changes to the meal, recipes, minute-by-minute cooking schedule, etc.) while viewing the minute-by-minute cooking schedule prior to preparing the meal. The cook may also use user interface module 102 to provide real-time feedback while preparing the meal according to the minute-by-minute cooking schedule. If interactive meal preparation system 100 determines that there is no input from the cook, then interactive meal preparation system 100 continues presenting (displaying) the requested minute-by-minute cooking schedule (block 604).

Otherwise, if interactive meal preparation system 100 determines that there is input from the cook, then interactive meal preparation system 100 may tune the minute-by-minute cooking schedule in real-time based on the received input (block 610, “Tune Minute-by-Minute Cooking Schedule in Real-Time”). For example, the cook may use user interface module 102 to request adjustments to the minute-by-minute cooking schedule. In response, interactive meal preparation system 100 may use cooking schedule generator module 108 to tune or revise the minute-by-minute cooking schedule based on the requested adjustments. In another example, while following the minute-by-minute cooking schedule to prepare the meal, the cook may use user interface module 102 to provide feedback, such as, by way of example, the cook's ability to perform the cooking steps and/or cooking blocks within the respective time durations, changes to cooking tools, changes to appliances, changes to the cook's schedule, etc. In response, interactive meal preparation system 100 may use cooking schedule generator module 108 to tune or revise the minute-by-minute cooking schedule based on the feedback provided by the cook.

Block 604 may also be followed by decision block 608 (“Input from Smart Appliance?”), where interactive meal preparation system 100 determines whether there is any input from the smart appliances being utilized while preparing the meal in accordance with the minute-by-minute cooking schedule. For example, a smart appliance being utilized to prepare the meal may use appliance interface module 110 to provide real-time feedback regarding its operation and/or the preparation of the food item by the smart appliance to interactive meal preparation system 100. If interactive meal preparation system 100 determines that there is no input from a smart appliance, then interactive meal preparation system 100 continues presenting (displaying) the requested minute-by-minute cooking schedule (block 604).

Otherwise, if interactive meal preparation system 100 determines that there is input from a smart appliance, then interactive meal preparation system 100 may tune the minute-by-minute cooking schedule in real-time based on the input from the smart appliance (block 610, “Tune Minute-by-Minute Cooking Schedule in Real-Time”). For example, interactive meal preparation system 100 may use cooking schedule generator module 108 to tune or revise the minute-by-minute cooking schedule based on the feedback provided by the smart appliance. Interactive meal preparation system 100 may then use user interface module 102 to present (display) the tuned or revised minute-by-minute cooking schedule for the meal for continued use by the cook in preparing the meal.

As indicated above, the embodiments described in the present disclosure may include the use of a special purpose or general purpose computer (e.g., processor 202 of FIG. 2) including various computer hardware or software modules, as discussed in greater detail herein. Further, as indicated above, embodiments described in the present disclosure may be implemented using computer-readable media (e.g., memory 204 of FIG. 2) for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method performed by a computing system including a processor, the method comprising:
identifying a first recipe, the first recipe including a first set of cooking steps, each of the cooking steps in the first set of cooking steps including a time duration;
identifying a second recipe, the second recipe including a second set of cooking steps, each of the cooking steps in the second set of cooking steps including a time duration;
determining a first set of cooking blocks for the first recipe based on the first set of cooking steps, each of the cooking blocks in the first set of cooking blocks including a time duration;
determining a second set of cooking blocks for the second recipe based on the second set of cooking steps, each of the cooking blocks in the second set of cooking blocks including a time duration;
determining a first required completion time for the first recipe;
determining a second required completion time for the second recipe;
generating a cooking schedule for the first recipe and the second recipe, the cooking schedule satisfying the first required completion time and the second required completion time; and
presenting the cooking schedule.

2. The method of claim 1, further comprising revising one or more of the cooking steps, cooking blocks, or time durations based on external data.

3. The method of claim 2, wherein the external data is from a smart appliance.

4. The method of claim 2, wherein the external data is feedback from a cook using the cooking schedule.

5. The method of claim 1, wherein the cooking schedule includes a first subset of the first set of cooking blocks being followed by a second subset of the second set of cooking blocks before the first recipe is completed.

6. The method of claim 4, wherein the cooking schedule is a minute-by-minute cooking schedule.

7. The method of claim 1, further comprising:
generating a sequence of cooking blocks from the first set of cooking blocks and the second set of cooking blocks based on the first required completion time and the second required completion time; and
confirming the availability of a cook for each of the cooking blocks in the sequence of cooking blocks.

8. The method of claim 7, further comprising revising the sequence of cooking blocks responsive to a determination that the cook is unavailable for at least one of the cooking blocks.

9. The method of claim 1, wherein the first recipe is provided by a cook, and further wherein the time duration for at least one cooking step in the first set of cooking steps is determined based on a verb in the cooking step.

10. A system configured to generate a cooking schedule for preparation of a meal, the system comprising:
a memory configured to store instructions; and
a processor configured to execute the instructions, wherein execution of the instructions causes the processor to:
identify a first recipe, the first recipe including a first set of cooking steps, each of the cooking steps in the first set of cooking steps including a time duration;
identify a second recipe, the second recipe including a second set of cooking steps, each of the cooking steps in the second set of cooking steps including a time duration;
determine a first set of cooking blocks for the first recipe based on the first set of cooking steps, each of the cooking blocks in the first set of cooking blocks including a time duration;
determine a second set of cooking blocks for the second recipe based on the second set of cooking steps, each of the cooking blocks in the second set of cooking blocks including a time duration;
determine a first required completion time for the first recipe;
determine a second required completion time for the second recipe;
generate a cooking schedule for the first recipe and the second recipe, the cooking schedule satisfies the first required completion time and the second required completion time; and
present the cooking schedule.

11. The system of claim 10, wherein the cooking schedule includes a first subset of the first set of cooking blocks being followed by a second subset of the second set of cooking blocks before the first recipe is completed.

12. The system of claim 10, wherein the cooking schedule is a minute-by-minute cooking schedule.

13. The system of claim 10, wherein execution of the instructions causes the processor to:
generate a sequence of cooking blocks from the first set of cooking blocks and the second set of cooking blocks based on the first required completion time and the second required completion time; and
confirm the availability of a cook for each of the cooking blocks in the sequence of cooking blocks.

14. The system of claim 13, wherein execution of the instructions causes the processor to revise the sequence of cooking blocks responsive to a determination that the cook is unavailable for at least one of the cooking blocks.

15. The system of claim 10, wherein the time duration for at least one cooking step in the first set of cooking steps is determined based on a verb in the cooking step.

16. A non-transitory computer-readable storage media storing thereon instructions that, in response to execution by a processor, causes the processor to:
identify a first recipe, the first recipe including a first set of cooking steps, each of the cooking steps in the first set of cooking steps including a time duration;
identify a second recipe, the second recipe including a second set of cooking steps, each of the cooking steps in the second set of cooking steps including a time duration;
determine a first set of cooking blocks for the first recipe based on the first set of cooking steps, each of the cooking blocks in the first set of cooking blocks including a time duration;
determine a second set of cooking blocks for the second recipe based on the second set of cooking steps, each of the cooking blocks in the second set of cooking blocks including a time duration;
determine a first required completion time for the first recipe;
determine a second required completion time for the second recipe;
generate a cooking schedule for the first recipe and the second recipe, the cooking schedule satisfies the first required completion time and the second required completion time; and
present the cooking schedule.

17. The non-transitory computer-readable storage media of claim 16, further storing thereon instructions that, in response to execution by the processor, causes the processor to revise the cooking schedule based on real-time feedback from a smart appliance.

18. The non-transitory computer-readable storage media of claim 16, further storing thereon instructions that, in response to execution by the processor, causes the processor to:
generate a sequence of cooking blocks from the first set of cooking blocks and the second set of cooking blocks based on the first required completion time and the second required completion time; and
confirm the availability of a cook for each of the cooking blocks in the sequence of cooking blocks.

19. The non-transitory computer-readable storage media of claim 18, further storing thereon instructions that, in response to execution by the processor, causes the processor to revise the sequence of cooking blocks responsive to a determination that the cook is unavailable for at least one of the cooking blocks.

20. The non-transitory computer-readable storage media of claim 16, wherein the cooking schedule includes a first subset of the first set of cooking blocks being followed by a second subset of the second set of cooking blocks before the first recipe is completed.
